(19) United States
(12) Patent Application Publication
(10) Pub. No.: US 2010/0003628 A1
(43) Pub. Date: Jan. 7, 2010

(54) COFFEE ROASTER

(76) Inventor: Honk-Sik Chung, Gyeonggido (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/564,575

(22) Filed: Sep. 22, 2009

Related U.S. Application Data
(63) Continuation of application No. PCT/KR2008/001812, filed on Apr. 1, 2008.

(30) Foreign Application Priority Data
Apr. 6, 2007 (KR) 10-2007-0034007

(51) Int. Cl. A23N 12/10; A23F 5/04

(52) U.S. Cl. 432/105; 99/467; 432/104; 34/130

(57) ABSTRACT

The present invention relates to a coffee roaster that roasts coffee beans by using heat emitted from a gas burner and a ceramic dome and has a hot water tank supplying hot water to coffee, wherein a rotary shaft rotating a roasting drum is rotatably supported on a base groove formed on the top surface of a base rod and a support groove formed on the bottom surface of a support rod, thereby permitting the rotary shaft to be removably mounted thereon, and wherein a heat-absorbing pipe is disposed in a high-temperature space between the gas burner and the inner wall surface of the ceramic dome, so as to allow a heat transfer medium to be forcedly circulated therethrough, and a heat-generating pipe disposed on a lower portion of a hot water tank in such a manner as to be submerged into the water in the hot water tank.

### CROSS-REFERENCE TO RELATED APPLICATIONS

This application claims the benefit under 35 U.S.C. § 119 of Korean Patent Application No. 10-2007-0034007, filed Apr. 6, 2007, and International Patent Application No. PCT/KR2008/001812, filed Apr. 1, 2008, which are hereby incorporated by reference in their entirety.

### FIELD OF THE INVENTION

The present invention relates to coffee roasters.

### BACKGROUND

Generally, roasted ground coffee is made by roasting coffee beans, adding some spices to the roasted coffee beans if necessary, blending and grinding them, and producing coffee powder. Thereafter, the roasted ground coffee is commercialized and distributed in the market. So as to drink coffee, next, the coffee powder is brewed with hot water.

Roasting coffee beans as the first process of making the roasted ground coffee is carried out by heating green coffee beans having light chocolate-like colors until they are changed to dark black colors.

Conventional coffee roasters are largely divided into the following three types: a heat pump type, a semi-heat pump type, and a direct fire type. The heat pump type coffee roaster conducts the roasting by directly blowing the hot air from a combustion chamber toward a rotary drum into which coffee beans are charged, the semi-heat pump type coffee roaster conducts the roasting by sending the hot air to the rotary drum into which the coffee beans are charged through an induction pipe so as not to allow fire to be directly contacted with the coffee beans, and the direct fire type coffee roaster conducts the roasting by charging the coffee beans into a net-like rotary drum such that the coffee beans in the rotary drum are directly contacted with the fire of a combustion device mounted under the rotary drum.

Further, in a conventional coffee roaster as shown in FIG. 5, a semi-cylindrical ceramic dome 2 is mounted inside a coffee roaster 1, and a gas burner 7 is mounted inside the ceramic dome 2. The ceramic dome 2 is heated by the gas heat emitted from the gas burner 7, thereby forming a high-temperature space by means of the far-infrared radiation heat generated from the heated ceramic dome 2, the gas heat emitted from the gas burner 7 and the hot air circulated in the inside space of the ceramic dome 2. A roasting drum 3 having coffee beans charged therein is rotated in the high-temperature space by means of a rotary shaft 12 being rotated by a motor 13, such that the outside and inside of the coffee beans are evenly roasted.

The conventional coffee roaster 1 as shown in FIG. 5 is generally installed at coffee shops for coffee sale only, such that the coffee beans are appropriately roasted in accordance with the customer's taste and preference, the roasted coffee beans are finely ground to produce the coffee powder which is, in turn, brewed with hot water, and roasted ground coffee is finally made.

Therefore, since the coffee beans should be frequently roasted according to the customer's different tastes, it is required that the roasting drum 3 should be drawn from the ceramic dome 2 so as to charge the coffee beans thereinto and next, it should be pushed again to the inside of the ceramic dome 2. In this case, the rotary shaft 12 rotating the roasting drum 3 cannot be separated from the roasting drum 3, thereby making it inconvenient to use.

Further, since hot water is necessarily needed to drink the roasted ground coffee, the hot water tank 5 storing the hot water made by gas heat therein is installed. However, so as to maintain the hot water at a predetermined temperature, a gas burner 7′ should be continuously used, thereby excessively increasing fuel consumption costs and giving much caution to the safety accidents in gas usage.

### BRIEF SUMMARY

The present invention relates to a coffee roaster that roasts coffee beans by using heat emitted from a gas burner and the inner wall surface of a ceramic dome and has a hot water tank adapted to supply hot water to coffee, wherein a rotary shaft rotating a roasting drum is rotatably supported on a semicircular base groove formed on the top surface of a base rod and a semicircular support groove formed on the bottom surface of a support rod, thereby enabling the rotary shaft to be easily mounted and removed, wherein a heat-absorbing pipe is disposed in a high-temperature space between the gas burner and the inner wall surface of the ceramic dome of the coffee roaster so as to forcedly circulate a heat transfer medium therethrough by means of a pump, thereby permitting the heat transfer medium to absorb the heat, and wherein a heat-generating generating pipe is submerged into the water in the hot water tank supplying hot water to the coffee such that the heat transfer medium heated in the heat-absorbing pipe is circulated therethrough so as to allow the water in the hot water tank to be heated, thereby resulting in reduction of the heating energy costs for the water in the hot water tank and enhancement of the convenience in the use of the hot water for the coffee.

### BRIEF DESCRIPTION OF THE DRAWINGS

FIG. 1 is a partially cut perspective view showing a coffee roaster according to the present invention.

FIG. 2 is a cross-sectional view showing the main parts of the coffee roaster according to the present invention.

FIG. 3 is a perspective view showing a state wherein a rotary shaft is mounted on a base rod and a support rod in the coffee roaster according to the present invention.

FIG. 4 is a front view showing a state where the coffee roaster having a hot water tank according to the present invention is installed on a vehicle.

FIG. 5 is a perspective view showing a conventional coffee roaster.

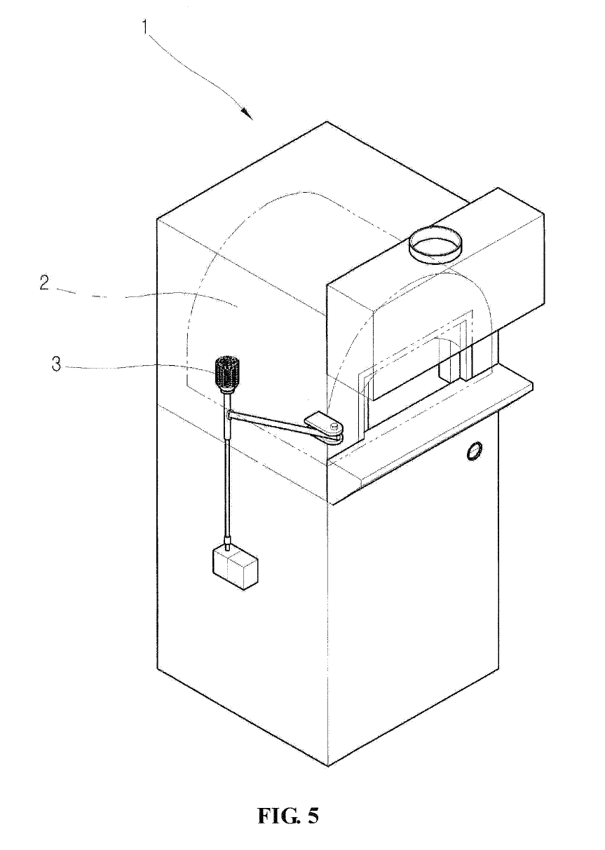

### DETAILED DISCLOSURE OF THE INVENTION

The present invention has been made in view of the above-mentioned problems occurring in the prior art, and it is an object of the present invention to provide a coffee roaster that is capable of easily mounting and removing a rotary shaft rotating a roasting drum such that the roasting drum can be easily removed from a ceramic dome and that is capable of transmitting the heat emitted from a gas burner and the radiation heat emitted from the ceramic dome to a hot water tank, such that water can be heated or maintained at a predetermined temperature, without using a gas burner only for heating the hot water tank.

To achieve the above object, according to the present invention, there is provided a coffee roaster having a heating device mounted therein, the coffee roaster comprising: a ceramic dome having a gas burner mounted at the bottom of the inside thereof and a heat-absorbing pipe disposed in a high-temperature space between the gas burner and the inner wall surface of the ceramic dome so as to allow a heat transfer medium to be forcedly circulated therethrough by means of a pump; and a hot water tank for storing water for brewing coffee therein, the hot water tank having a gas burner mounted at the bottom of the inside thereof for heating the water stored in the hot water tank and a heat-generating pipe disposed on a lower portion thereof in such a manner as to be submerged into the water in the hot water tank.

According to the present invention, preferably, a base rod and a support rod are mounted at the entrance side of the coffee roaster, the base rod having a base groove formed on the top surface thereof and the support rod having a support groove formed on the bottom surface thereof, thereby enabling a rotary shaft adapted to rotate a roasting drum to be easily removably mounted on the base rod and the support rod.

According to the present invention, there is provided a coffee roaster that can simply mount and remove the rotary shaft transmitting the rotary force of the motor to the roasting drum thereon, thereby increasing the convenience in use thereof.

Further, the water in the hot water tank can be heated by using the heat energy used during the roasting of the coffee beans, thereby reducing the gas consumption required for heating the hot water tank and saving the management costs for the coffee roaster.

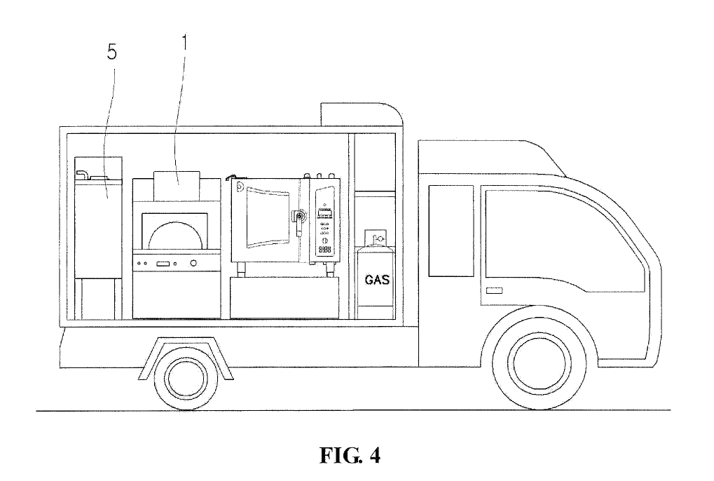

Especially, when the coffee roaster of this invention is installed at general shops, it is convenient to use, and if it is mounted on a moving vehicle, it occupies only a part of the limited area on the moving vehicle, as shown in FIG. 4. Therefore, the coffee roaster of this invention can be advantageously applied to the moving vehicles for selling coffee since it is easily mounted thereon, allows an amount of gas consumption to be reduced, and does not need a large number of gas tanks for heating hot water.

Hereinafter, an explanation on a coffee roaster according to a preferred embodiment of the present invention will be given with reference to the attached drawings.

The present invention is applicable to a coffee roaster 1 having a ceramic dome 2 and a gas burner 7 mounted in the ceramic dome so as to roast coffee beans.

According to the coffee roaster 1, the ceramic dome 2 is heated by means of the gas burner 7 until it is heated up to a predetermined temperature, and a roasting drum 3 is rotated by means of a rotary shaft 12 connected to a motor 13 in a high-temperature space heated by means of the radiation heat generated from the heated ceramic dome 2 and the gas heat emitted from the gas burner 7, such that the coffee beans charged in the roasting drum 3 are evenly roasted.

The coffee roaster 1 includes a base rod 14 at the front of one side thereof, the base rod 14 having a generally semicircular base groove 14a formed on the top surface thereof.

Further, the coffee roaster 1 includes a support rod 15 at the rear of one side thereof, the support rod 15 having a generally semicircular support groove 15a formed on the bottom surface thereof.

The rotary shaft 12, which transmits the rotary force of the motor 12 to the roasting drum 3, is rotatably supported on the base groove 14a of the base rod 14 and the support groove 15a of the support rod 15, thereby permitting the roasting drum 3 to be rotated.

In case where the roasting drum 3 is drawn from the ceramic dome 2 so as to remove the roasted coffee beans from the roasting drum 3 and to put new coffee beans to be roasted thereinto, the rotary shaft 12 can be easily removed from the semicircular base groove 14a formed on the top surface of the base rod 14 and the semicircular support groove 15a formed on the bottom surface of the support rod 15.

Additionally, so as to transmit the heat emitted from the gas burner 7 and the ceramic dome 2 of the coffee roaster 1 to the hot water tank 5, a heat-absorbing pipe 11a is disposed bent in a zigzag shape at one side of a pipe 11 adapted to forcedly circulate a heat transfer medium like water or oil by means of a pump 10 in such a manner as to be placed in a high-temperature space between the gas burner 7 and the inner wall surface of the ceramic dome 2, thereby enabling the heat transfer medium to absorb the heat emitted from the gas burner 7 and the ceramic dome 2.

On the other hand, a heat-generating pipe 11b is disposed bent in a zigzag shape at the other side of the pipe 11 in such a manner as to be submerged in the water of a hot water tank 5, thereby enabling the water in the hot water tank 5 to be heated.

The heat-absorbing pipe 11a and the heat-generating pipe 11b of the pipe 11 may have a variety of shapes including a coil shape as well as the above-mentioned zigzag shape, and of course, the heat transfer medium used to absorb and generate heat may include various fluids besides water.

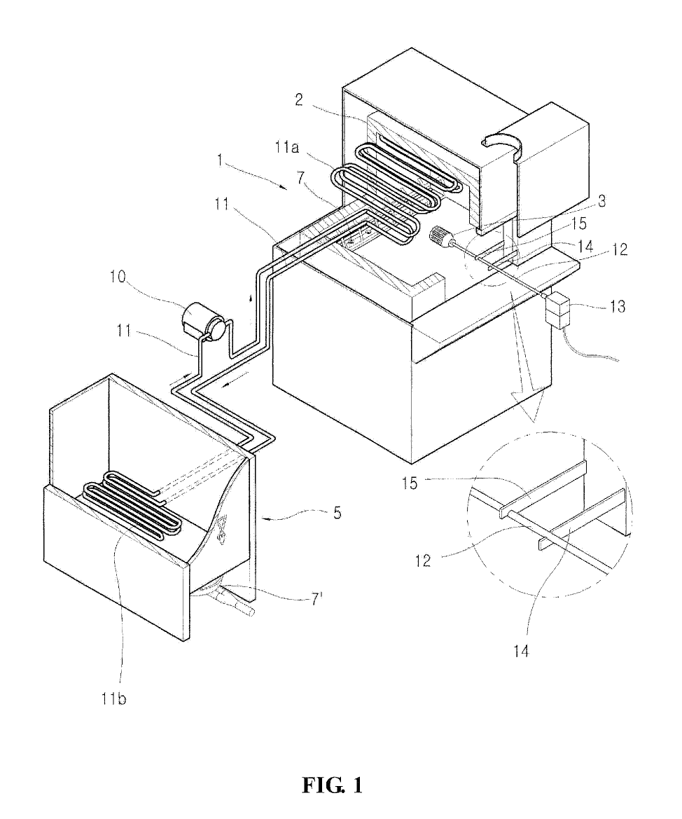

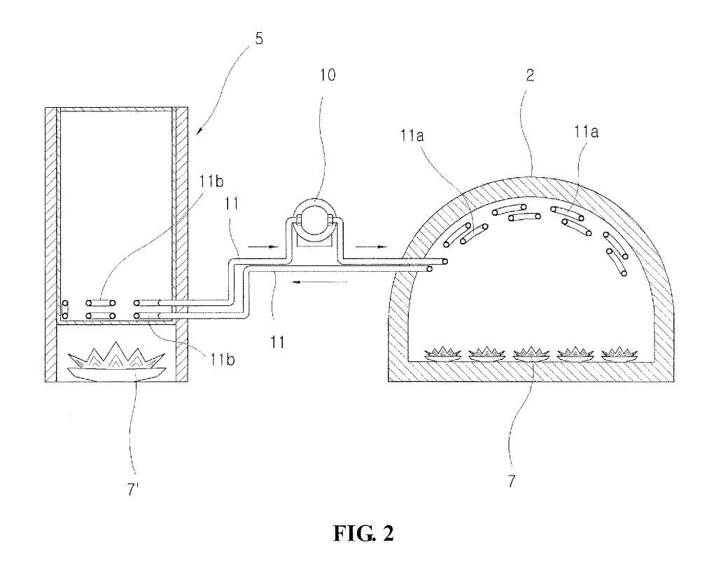

Under the above-mentioned configuration, an explanation on the operation of the coffee roaster according to the present invention will be given hereinafter with reference to FIGS. 1 to 4.

The gas burner 7 is activated so as to roast the coffee beans, and the ceramic dome 2 is heated by means of the gas burner 7 until heated up to a predetermined temperature.

The hot water tank 5 is charged with water and heated by means of a gas burner 7′ until it reaches a predetermined temperature.

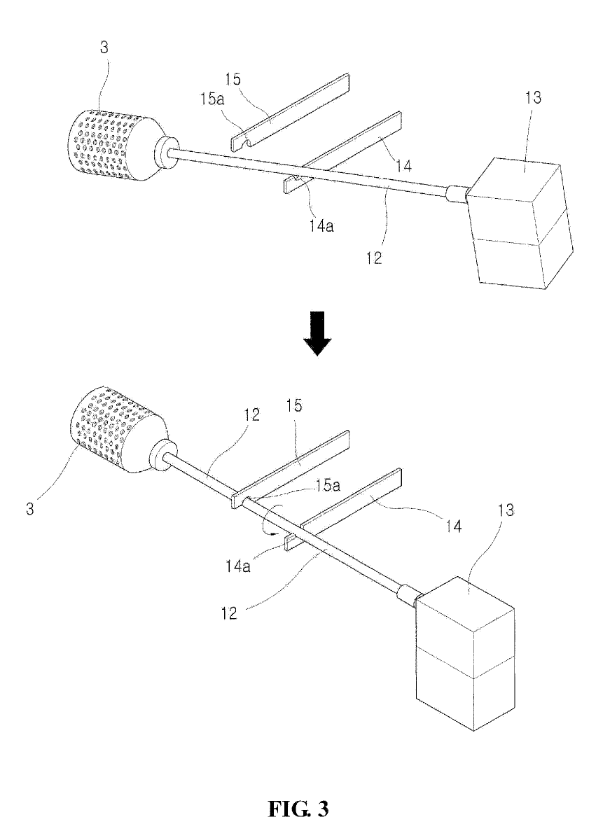

If the ceramic dome 2 of the coffee roaster 1 reaches the predetermined temperature, as shown in FIG. 3, the motor 2 side of the rotary shaft 12 rotating the roasting drum 3 is supportedly mounted on the base groove 14a formed on the top surface of the base rod 14, and the roasting drum 3 side of the rotary shaft 12 is supportedly mounted on the support groove 15a formed on the bottom surface of the support rod 15. Next, the motor 13 is activated to cause the rotary shaft 12 to rotate the roasting drum 3.

At this time, the motor 13 is heavy such that the roasting drum 3 of the rotary shaft 12 is moved upwardly with respect to the base groove 14a of the base rod 14 and is thus fittingly caught by the support groove 15a of the support rod 15, thereby enabling the rotary shaft 12 to be rotated, while maintaining its horizontal level.

Thus, as the roasting drum 3 is rotated, the coffee beans charged in the roasting drum 3 are evenly mixed and roasted by means of the gas heat emitted from the gas burner 7 and the radiation generated from the ceramic dome 2.

If the roasting is finished, the rotary shaft 12 is easily removed from the base groove 14a and the support groove 15a, such that the roasting drum 3 can be drawn to the outside of the coffee roaster 1.

According to the present invention, the water stored in the hot water tank 5 can be heated to or maintained at a predetermined temperature by using the gas heat in the coffee roaster 1 and the radiation heat in the ceramic dome 2, during the roasting or even though the roasting is finished.

If the ceramic dome 2 is heated to reach the predetermined temperature, the pump 10 connected to the pipe 11 is activated to cause the heat transfer medium to be forcedly circulated.

The gas heat emitted from the gas burner 7 and the radiation heat from the ceramic dome 2 serve to heat the heat transfer medium passing through the heat-absorbing pipe 11a, and the heated heat transfer medium is passed through the pipe 11 and the heat-generating pipe 11b submerged into the water of the hot water tank 5, thereby releasing the heat to the water. After that, the heat transfer medium is passed through the pipe 11 again and is conveyed to the heat-absorbing pipe 11a, thereby repeatedly performing the heat exchanging and circulating process.

The water in the hot water tank 5 can be heated or maintained at a predetermined temperature, without having the gas burner 7′ only for heating the hot water tank 5.

Especially, only if the ceramic dome 2 is heated, it can emit heat therefrom for a long time, such that even though the use of the gas burner 7 of the coffee roaster 1 is finished, the radiation heat emitted from the ceramic dome 2 for a long time is transmitted through the pipe 11 to the hot water tank 5, such that the predetermined temperature of hot water can be maintained for a long time, thereby minimizing the use of the gas burner 7′ only for the hot water tank 5.

What is claimed is:

1. A coffee roaster having a heating device mounted therein wherein a heat-absorbing pipe (11a) is disposed in a high-temperature space between a gas burner (7) and the inner wall surface of a ceramic dome (2) so as to allow a heat transfer medium to be forcedly circulated therethrough by means of a pump (10), and a heat-generating pipe (11b) is disposed on a lower portion of a hot water tank (5) in such a manner as to be submerged into the water in the hot water tank (5).

2. The coffee roaster as defined in claim (1), wherein a base rod (14) and a support rod (15) are mounted at the entrance side of the coffee roaster, the base rod (14) having a base groove (14a) formed on the top surface thereof and the support rod (15) having a support groove (15a) formed on the bottom surface thereof, thereby enabling a rotary shaft (12) adapted to rotate a roasting drum (3) to be easily removably mounted on the base rod (14) and the support rod (15).
